(19) United States
(12) Patent Application Publication
(10) Pub. No.: US 2014/0215361 A1
(43) Pub. Date: Jul. 31, 2014

(54) APPARATUS, METHOD AND COMPUTER READABLE RECORDING MEDIUM FOR SENDING CONTENTS SIMULTANEOUSLY THROUGH A PLURALITY OF CHATTING WINDOWS OF A MESSENGER SERVICE

(71) Applicant: NAVER CORPORATION, Seongnam-si (KR)

(72) Inventors: Jeong Yong Hwang, Seongnam-si (KR); Jeanie Jung, Seongnam-si (KR)

(73) Assignee: NAVER CORPORATION, Seongnam-si (KR)

(21) Appl. No.: 14/166,507

(22) Filed: Jan. 28, 2014

(30) Foreign Application Priority Data
Jan. 28, 2013 (KR) 10-2013-0009016

(51) Int. Cl. H04L 12/24; G06F 3/0481

(52) U.S. Cl. CPC H04L 41/22; G06F 3/0481
USPC 715/758

(57) ABSTRACT

A messenger server includes a messenger processing module which creates a chatting window in accordance with a request of a user terminal, and transmits and receives a message which is input through the chatting window; and a multiplex transmitting module which simultaneously multiplex transmits contents selected by a user terminal to at least two chatting rooms which are selected from a plurality of chatting rooms in which a user of the user terminal joins.

### CROSS-REFERENCE TO RELATED APPLICATIONS

This application claims priority to and the benefit of Korean Patent Application No. 10-2013-0009016 filed in the Korean Intellectual Property Office on Jan. 28, 2013, the entire contents of which are incorporated herein by reference.

### TECHNICAL FIELD

The present invention relates to a messenger service, and more particularly, to an apparatus, a method, and a computer readable recording medium for sending contents simultaneously through a plurality of chatting windows of a messenger service which simultaneously multiplex transmits the contents, which are received by users through a plurality of chatting windows of the messenger service.

### BACKGROUND ART

Generally, the Internet is an open type network which is configured to allow anyone to freely connect to a computer of the other party to be accessed anywhere in the world by applying a common protocol called a TCP/IP. The Internet is also used to transmit multimedia information as a compression technique in addition to transmission of basic text information to provide various services such as electronic mail, file transmission or world wide web (WWW).

The usage of the Internet has sharply increased not only domestically but also worldwide. The importance of the Internet has rapidly increased as a strategic tool for enhancing efficiency and productivity over all fields of existing industries. Further, opportunities for new businesses through the Internet is continuously created, and as the area of business extends, service providers which use the Internet are also increased.

Recently, users who want various forms of communication perform communications using a homepage, an e-mail, or a phone auto response service (ARS). However, the homepage and e-mail have a disadvantage in that they do not provide real time communication between users. In contrast, the phone ARS has an advantage in terms of a real time property but has a disadvantage in terms of high communication cost to the user.

In contrast, as a useful method for real time transmission of information using the Internet, there is an instant messenger service. The purpose of the messenger service is to transmit a simple message between users in real time. By using the messenger service, two users can communicate with each other in real time through transmitted texts. This is because the messenger service places importance on the real time property of the message so as to immediately transmit input contents.

Messenger client programs such as the instant messenger service provide not only a function of simply transmitting a message but also a function of transmitting emoticon, flashcon, gifticon or a file, to the other party of the conversation through a conversation window of a messenger service.

Messenger client programs also provide not only one to one conversation but also a group conversation function through which multiple people may chat through one conversation window. In order to perform a group conversation, a plurality of conversation parties are selected for conversation to create a group conversation window or a converser is added to an already existing conversation window in the messenger client program.

Recently, messenger services began providing various types of extended services other than a simple chatting function. For example, as a technique regarding a method of creating a group chatting room, Patent Document 1 (Korean Patent Application Laid-Open No. 2010-0095205, entitled “System for Providing Chatting” and applied by THINKPOOL CO., LTD.) discloses a chatting system which may be operated together with a stock trading system to automatically create a chatting room for every stock item for at least one item even when a user does not request to create a chatting room. Patent Document 2 (Korean Patent Application Laid-Open No. 2009-0131493, entitled “Real-Time Search Word Chatting Room Provision Method Which Uses the Internet” and invented by Min Ho Choi) discloses a configuration which when there are users who input same search words, provides a chatting window between similar users by forming a chatting room between the users.

Patent Document 3 (Korean Patent Application Laid-Open No. 2003-0022462, entitled “Method for Chatting with Desiring Person Using E-Mail” and invented by Bong Rae Park) and Patent Document 4 (Korean Patent Application Laid-Open No. 2003-0072844, entitled “Method for Using E-Mail to Drive Persons to Chat” and invented by Bong Rae Park) disclose a configuration in which an e-mail is transmitted to a party who wants to chat using an e-mail and the other party who receives the e-mail provides a chatting service between a user who transmits the e-mail and the user who receives the e-mail using the received e-mail.

Recently, the usage of a mobile messenger service has been rapidly increasing due to the wide use of smart phones. Along with this increase, a necessity of simultaneously transmitting a message to acquaintances who are distributed in plural chatting rooms has also increased.

However, according to a chatting system according to the related art, a user needs to individually visit the plurality of chatting rooms in which the user joins to repeatedly input or request to transmit the same message, which is inconvenient. The user also needs to individually visit the chatting rooms to which the message is transmitted to check and answer a feedback for the message which is transmitted by the user. Further, if the user wants to share a video which is captured by the user, the user needs to temporarily store the captured video as a file of a video on demand (VOD) format and then transmit the video to every chatting room.

Therefore, a necessity of a method for simultaneously transmitting contents to a plurality of chatting rooms and checking feedbacks thereof is needed.

### SUMMARY OF THE INVENTION

The present invention has been made in an effort to provide an apparatus, a method, and a computer readable recording medium for sending various types of contents simultaneously through a plurality of chatting windows of a messenger service to a plurality of joining chatting rooms.

The present invention has been made in an effort to further provide an apparatus, a method, and a computer readable recording medium for sending contents simultaneously through a plurality of chatting windows of a messenger service which is capable of conveniently transmitting a video which is captured by a user to acquaintances who are distributed into a plurality of chatting rooms in real time.

The present invention has been made in an effort to further provide an apparatus, a method, and a computer readable recording medium for sending contents simultaneously through a plurality of chatting windows of a messenger service which allows a user to simultaneously transmit various types of contents which are selected by the user to at least one chatting room selected from a plurality of chatting rooms in which the user joins.

The present invention has been made in an effort to further provide an apparatus, a method, and a computer readable recording medium for sending contents simultaneously through a plurality of chatting windows of a messenger service which allows a user to simultaneously transmit various types of contents which are selected by the user to a plurality of joining chatting rooms and collectively provide feedbacks from the chatting rooms.

A characteristic configuration of the present invention for achieving the objects of the present invention which have been described above and a unique effect of the present invention which will be described below is as follows.

An aspect of the present invention provides a messenger server including: a messenger processing module which creates a chatting window in accordance with a request of a user terminal and transmits and receives a message which is input through the chatting window with respect to another user terminal; and a multiplex transmitting module which simultaneously multiplex transmits contents selected by a user terminal to user terminals of other members who join a plurality of chatting rooms which is selected from a plurality of chatting rooms in which a user of the user terminal joins in accordance with a content multiplex transmitting request.

The multiplex transmitting module may simultaneously multiplex transmit the selected contents to all of the plurality of chatting rooms in which the user of the user terminal joins in accordance with the content multiplex transmitting request.

The multiplex transmitting module may further include a tag inserting unit which inserts a tag notifying that the transmitted contents into the multiplex transmitted contents are multiplex transmitted contents.

The multiplex transmitting module may further include a feedback processing unit which collectively stores feedback information in a database when the feedback information is generated in specific chatting windows corresponding to the chatting rooms that received the multiplex transmitted contents. The feedback information may include a comment or evaluation information on the contents.

The multiplex transmitting module may further include a statistic processing unit which checks whether members of the chatting rooms that received the multiplex transmitted contents have browsed the multiplex transmitted contents and generates statistic information regarding the browsing.

The multiplex transmitting module may further include a charging unit which charges a predetermined amount of fees when the multiplex transmitted contents are simultaneously multiplex transmitted to a predetermined number or more of chatting rooms. The contents may be any one selected from a text, an image, a video, and a real time broadcasting video.

Another aspect of the present invention provides a content multiplex transmitting method through a chatting window of a messenger service in which steps which are executed in the messenger server includes: creating a chatting window in accordance with a request of a user terminal and transmits and receiving a message which is input through the chatting window with respect to another user terminal; selecting contents to be multiplex transmitted by the user terminal in accordance with a content multiplex transmitting request from the user terminal; and simultaneously multiplex transmitting the selected contents to user terminals of other members who join in a plurality of chatting rooms selected from a plurality of chatting rooms in which a user of the user terminal joins.

The multiplex transmitting of the selected contents may simultaneously multiplex transmit the selected contents to all of the plurality of chatting rooms in which the user of the user terminal join in accordance with the content multiplex transmitting request.

The multiplex transmitting of the selected contents may further include inserting a tag notifying that the transmitted contents are multiplex transmitted contents into the multiplex transmitted contents.

The method may further include collectively storing generated feedback information in a database when the feedback information is generated in a specific chatting window for the contents multiplex transmitted to the plurality of chatting rooms.

The feedback information may include a comment or evaluation information on the contents.

The method may further include checking whether the users browse the multiplex transmitted contents and generating statistic information regarding the browsing.

The method may further include charging a predetermined amount of fees when the multiplex transmitted contents are simultaneously multiplex transmitted to a predetermined number or more of chatting rooms or users.

The contents may be any one selected from a text, an image, a video, and a real time broadcasting video.

Information for receiving the content multiplex transmitting method through the chatting windows of the messenger service may be stored in a server computer readable recording medium. The recording medium includes all types of recording media in which a program and data are stored so as to be readable by a computer system. Examples of the recording medium include a read only memory (ROM), a random access memory (RAM), a compact disk (CD), a digital video disk (DVD)-ROM, a magnetic tape, a floppy disk, and an optical data storage device, and also include a medium which is implemented as carrier waves (e.g., transmission through the Internet). Further, the recording medium is distributed to computer systems connected through a network, so that a computer readable code may be stored and executed by a distribution method.

As described above, according to the present invention, differently from an advertising message which is distributed to all users who are not acquaintances and listed on an address book or an e-mail, a message is actively transmitted through a reliable network among reliable acquaintances which create a chatting room to communicate with each other and thus contents may be recommended or promoted.

According to the present invention, when a user who watches a message or a video transmitted through the chatting room thinks that the message is useful, the user shares the message or the video in another chatting room in which the user joins in real time so that an effect which distributes the message through a network between acquaintances may be maximized.

### BRIEF DESCRIPTION OF THE DRAWINGS

FIG. 1 is a diagram illustrating a concept of a multiplex transmitting contents through chatting windows of a messenger service according to an exemplary embodiment of the present invention.

FIG. 2 is a diagram illustrating a system for multiplex transmitting contents through chatting windows of a messenger service according to an exemplary embodiment of the present invention.

FIG. 3 is a block diagram illustrating a detailed structure of a messenger server according to an exemplary embodiment of the present invention.

FIG. 4 is a flow chart illustrating a process for multiplex transmitting contents through chatting windows of a messenger service according to an exemplary embodiment of the present invention.

FIG. 5 is a diagram illustrating an example of content multiplex transmission through chatting windows of a messenger service according to an exemplary embodiment of the present invention.

### DETAILED DESCRIPTION OF THE EXEMPLARY EMBODIMENTS

The present invention will be described in detail with reference to the accompanying drawings based on specific exemplary embodiments in which the present invention may be carried out as an example. The exemplary embodiments will be described in detail enough to carry out the present invention by those skilled in the art. It should be understood that various exemplary embodiments of the present invention are different from each other, but need not to be mutually exclusive. For example, a specific figure, a structure, and a characteristic described herein may be implemented as another exemplary embodiment without departing from the spirit and the scope of the present invention in relation to an exemplary embodiment. Further, it should be understood that a position or a displacement of an individual constituent element in each disclosed exemplary embodiment may be changed without departing from the spirit and the scope of the present invention. Like reference numerals in the drawing denote the same or similar function throughout several aspects.

The present invention discloses an apparatus for multiplex transmitting contents through chatting windows of a messenger service, which simultaneously multiplex transmits the contents selected by a user through a plurality of chatting windows of the messenger service. Contents which may be simultaneously transmitted may be any type of contents. For example, according to the exemplary embodiment of the present invention, not only text, but also any of transmittable contents such as an image, a video, or a real time broadcasting video may be simultaneously transmitted.

A user who wants to multiplex transmit contents according to the exemplary embodiment of the present invention may simultaneously transmit the contents to all of a plurality of chatting windows in which the user joins, or select at least one chatting window from the plurality of chatting windows in which the user joins to multiplex transmit the contents only to the selected chatting window according to another exemplary embodiment of the present invention.

After multiplex transmitting the contents to the chatting windows according to the exemplary embodiment of the present invention, another user who joins the chatting windows may again multiplex transmit the multiplex transmitted contents to a plurality of other chatting windows. By doing this, contents may be naturally spread through an acquaintance network.

A messenger service in the following detailed description includes a messenger service which is driven on a general desktop computer and may also be identically applied to a mobile messenger service which is driven in a mobile terminal.

A “user terminal” in the following description is a concept including not only a general desktop computer but also a smart phone. If a digital device includes a memory unit and is mounted with a microprocessor to have an arithmetic ability, such as a mobile communication terminal, a desktop computer, a notebook computer, a workstation, a palmtop computer, a personal digital assistant (PDA) or a web pad, any of the digital devices may be adopted as a user terminal according to the present invention. Further, a “user terminal” in the present invention may be a mobile terminal (for example, smart phone) which has a function as a camera.

Hereinafter, the exemplary embodiments of the present invention will be described with reference to the accompanying drawings in detail so that those skilled in the art may easily carry out the present invention.

### Concept of Content Multiplex Transmission Through Chatting Windows of Messenger Service

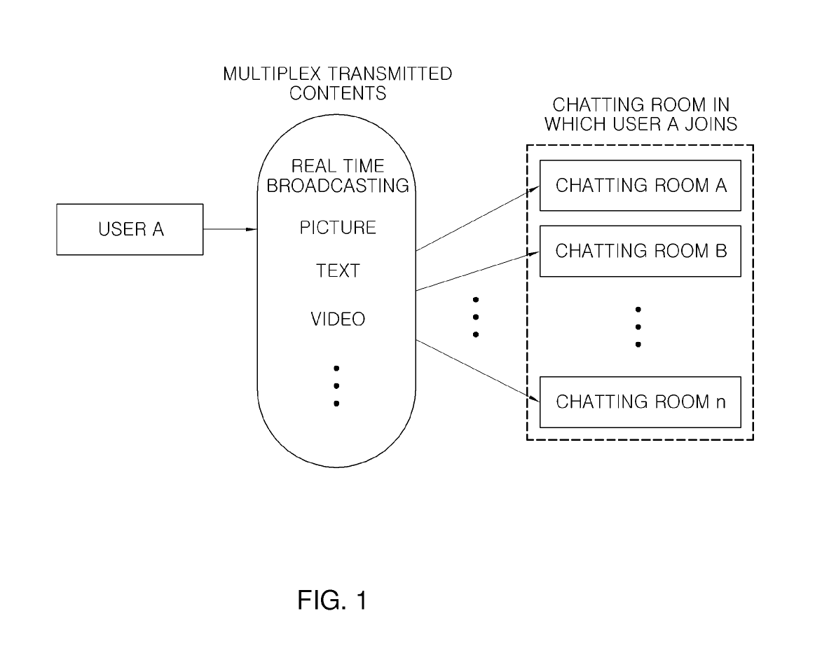

FIG. 1 is a diagram illustrating a concept of a content multiplex transmission through chatting windows of a messenger service according to an exemplary embodiment of the present invention. Referring to FIG. 1, a user A selects contents to be multiplex transmitted through a plurality of chatting windows. The type of contents may be any type of contents such as real time broadcasting, a picture, a text, and a video, as described above.

The contents selected as described above are simultaneously transmitted to n chatting rooms (for example, a chatting room A, a chatting room B, . . . , a chatting room n) in which a user A joins. The user may also randomly select m chatting rooms among n chatting rooms to multiplex transmit the contents thereto, according to the exemplary embodiment of the present invention.

Accordingly, the contents which are transmitted by the user A may be simultaneously displayed on chatting windows of chatting rooms by only one transmission request and the user may simultaneously transmit the same contents to the individual chatting rooms without separately visiting each of the chatting rooms.

A message is posted or a feedback occurs in the chatting rooms to which the contents are simultaneously multiplex transmitted. Feedback information is connected with respect to the multiplex transmitted contents so that feedback information which is posted in the chatting rooms is combined. By doing this, the user who requests the multiplex transmission may check the feedback information at once without separately visiting the chatting rooms to which the contents are multiplex transmitted.

### Content System for Multiplex Transmitting Content Through Chatting Windows of Messenger Service

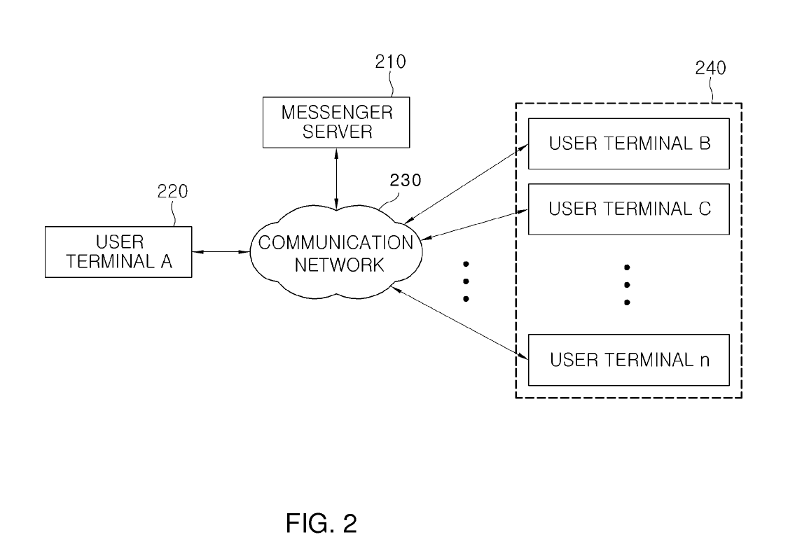

FIG. 2 is a diagram illustrating a system for multiplex transmitting contents through chatting windows of a messenger service according to an exemplary embodiment of the present invention. Referring to FIG. 2, a system according to an exemplary embodiment of the present invention includes a messenger server 210, a user terminal A 220 which requests multiplex transmission, a communication network 230, and a plurality of user terminals 240 (a user terminal B, a user terminal C, . . . , a user terminal n) which join a plurality of chatting rooms in which the user terminal A 220 joins.

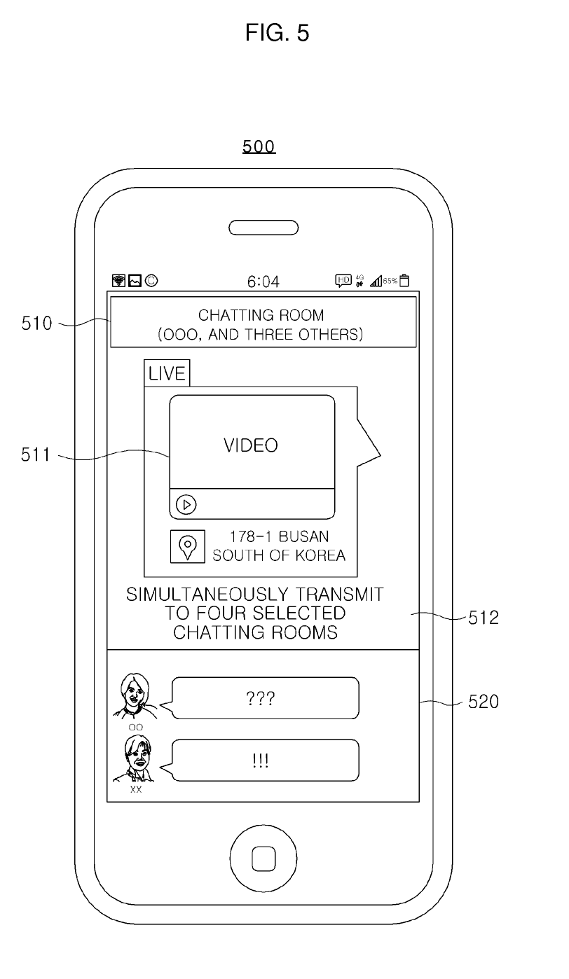

The user terminal A 220 accesses the messenger server 210 to be logged in, creates a chatting room or joins a created chatting room, and then multiplex transmits various selected contents to user terminals 240 which join the plurality of chatting rooms in which the user terminal A 220 joins through the messenger server 210, according to the exemplary embodiment of the present invention, as illustrated in FIG. 5.

That is, the contents which are selected by the user terminal A 220 are transmitted to the messenger server 210 through the communication network 230 and the messenger server 210 simultaneously multiplex transmits the selected contents to the user terminals 240 of other members who join the plurality of chatting rooms in which the user of the user terminal A 220 joins. By doing this, in the user terminals 240 of other members in the same chatting rooms as the plurality of chatting rooms in which the user terminal A 220 joins, the same contents may be simultaneously checked through the respective chatting windows.

The user terminals 220 and 240 according to the exemplary embodiment of the present invention have an input/output function for a user to access the messenger server 210 through the communication network 230 to create the chatting room or enter the created chatting room or input or check a message through the chatting window. If a digital device includes a memory unit and is mounted with a microprocessor to have an arithmetic ability, such as not only a mobile communication terminal including a smart phone, but also a desktop computer, a notebook computer, a workstation, a palmtop computer, a personal digital assistant (PDA) or a web pad, any of the digital devices may be adopted as the user terminals 220 and 240 according to the present invention.

The communication network 230 may be configured regardless of the communication types such as a wired or wireless communication and configured by various communication networks such as a personal area network (PAN), a local area network (LAN), a metropolitan area network (MAN), or a wide area network (WAN). Further, the communication network 230 may be a known world wide web (WWW) and may use wireless transmission technique which is used for a short range communication, such as infrared data association (IrDA) or a Bluetooth.

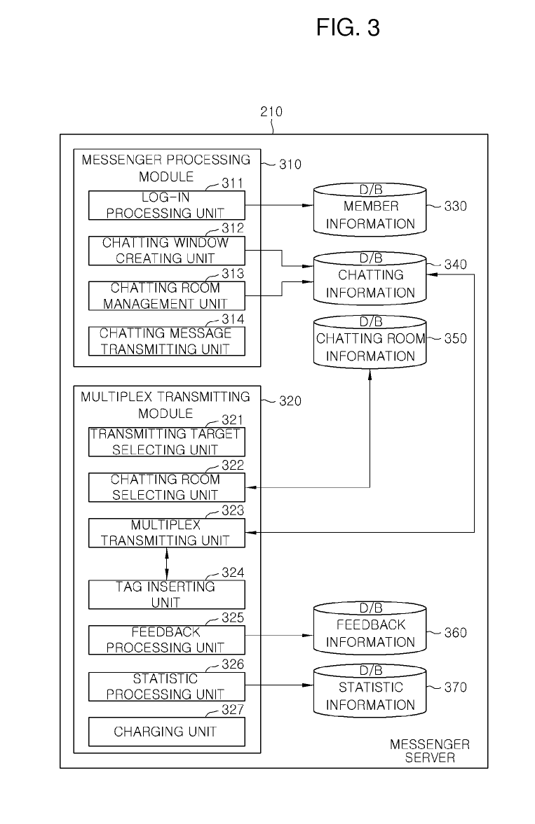

FIG. 3 is a block diagram illustrating a detailed structure of a messenger server according to an exemplary embodiment of the present invention. Referring to FIG. 3, the messenger server 210 includes a messenger processing module 310 which performs a basic messenger processing function and a multiplex transmitting module 320 which provides a function of multiplex transmitting the contents selected according to an exemplary embodiment of the present invention through a plurality of chatting windows of a messenger service.

The messenger processing module 310 includes a log-in processing unit 311, a chatting window creating unit 312, a chatting room management unit 313, and a chatting message transmitting unit 314. Further, the multiplex transmitting module 320 includes a transmitting target selecting unit 321, a chatting room selecting unit 322, a multiplex transmitting unit 323, a tag inserting unit 324, a feedback processing unit 325, a statistic processing unit 326, and a charging unit 327.

In the following description, a description and a configuration of general functions of the messenger service will be omitted, but parts related to the characteristics of the present invention will be mainly described. Further, all or parts of the functional units which are included in the messenger processing module 310 of the messenger server 210 may be included in a client program which is installed in the user terminals 220 and 240 and some functions of the functional units may interwork to each other or be distributed to be processed by the server and the client system.

When the user terminal 220 or 240 accesses the messenger server 210 to request a log-in to the messenger server 210, the log-in processing unit 311 of the messenger processing module 310 performs a log-in processing with reference to information stored in a member information database 330 and may perform authentication by interworking with the authentication server described above.

When the user terminal 220 or any of the user terminals 240 creates a chatting room and requests to create a chatting window after logging in the messenger server 210, the chatting window creating unit 312 performs a function of creating a chatting window in accordance with the request. In this case, the chatting information which is input through the chatting window may be stored in the chatting information database 340.

The chatting room management unit 313 performs a function of managing the created chatting room and managing information regarding the chatting room and information on a plurality of members (for example, a chatting room ID, a member ID, or member information) who join the created chatting room. Information on each chatting room may be stored in the chatting room information database 350.

The chatting message transmitting unit 314 performs a function of receiving a chatting message input through the chatting window from the user terminal 220 or 240 to transmit the chatting message to the other user terminal 220 or 240. The chatting messages which are transmitted through the chatting message transmitting unit 314 are stored in the chatting information database 340.

Hereinafter, the functions of the units of the multiplex transmitting module 320 will be described.

The transmitting target selecting unit 321 provides a function which allows the user terminal 220 to perform multiplex transmission to execute a multiplex transmitting function and select contents to be transmitted.

The chatting room selecting unit 322 provides a function of inputting selection information for a chatting room to which contents will be selectively multiplex transmitted according to the exemplary embodiment of the present invention. In this case, a user who wants to perform the multiplex transmission processing may collectively select all chatting rooms in which the user joins according to the exemplary embodiment of the present invention, or select at least one chatting room among all the chatting rooms in which the user who wants to multiplex transmit the contents joins according to another exemplary embodiment of the present invention.

The multiplex transmitting unit 323 performs a function of simultaneously multiplex transmitting the contents which are selected by the transmitting target selecting unit 321 to the user terminals 240 of other members who join the chatting rooms selected by the chatting room selecting unit 322.

The tag inserting unit 324 inserts a tag notifying that the transmitted contents are multiplex transmitted contents into the contents which are multiplex transmitted by the multiplex transmitting unit 323 according to the exemplary embodiment of the present invention. Therefore, when the contents which are multiplex transmitted to the user terminal 240 by the multiplex transmitting unit 323 are displayed in a chatting window of the user terminal 240, as illustrated in FIG. 5, the contents may be additionally displayed as multiplex transmitted contents, which is different from other input contents.

When feedback information (for example, a comment or evaluation of the contents) for contents which are multiplex transmitted to the plurality of chatting rooms through the multiplex transmitting unit 323 is generated in a specific chatting window, the feedback processing unit 325 collectively stores the feedback information in a feedback information database 360. Therefore, a unique identification number for identifying the multiplex transmitted contents is desirably allocated to the multiplex transmitted contents. If the feedback information for the contents is generated, the feedback information is mapped to the unique identification number for identifying the contents to be stored so that the feedback information may be managed for every multiplex transmitted content.

The statistic processing unit 326 collects feedback information or browsing information on the multiplex transmitted contents, and performs a function of creating a statistic material for checking how many people read the multiplex transmitted contents or which chatting members read the content or when the contents are read, and the created statistic material is stored in a statistic information database 370. Accordingly, the user who requests to multiplex transmit the contents may check the feedback information on the multiplex transmitted contents at once and also check the statistic material regarding the browsing of the contents at once.

The content multiplex transmission according to the exemplary embodiment of the present invention may be used as means for advertisement so that the charging unit 327 may charge a fee when the function is provided to be charged or the contents are simultaneously multiplex transmitted to a predetermined number or more of chatting rooms or users.

The respective constituent elements of the messenger server 210 are separately indicated in the drawing so as to represent that the constituent elements may be functionally and logically separated. However, this does not mean that the respective constituent elements are essentially physically implemented as separate constituent elements or separate codes.

In this specification, the respective functional units (or modules) may mean a functional and structural combination of a hardware which carries out a technical spirit of the present invention and a software which drives the hardware. For example, those skilled in the art may easily deduct that the functional units may refer to a predetermined code or a logical unit of a hardware resource for executing the predetermined code but may not necessarily refer to a physically connected code or one type of hardware.

Database described in the specification may refer to a functional and structural combination of a software and a hardware in which information corresponding to the database is stored. The database includes any types of a data storage medium and a data structure in which information corresponding to the database is stored.

### Method Multiplex Transmitting Contents Through Chatting Windows of Messenger Service

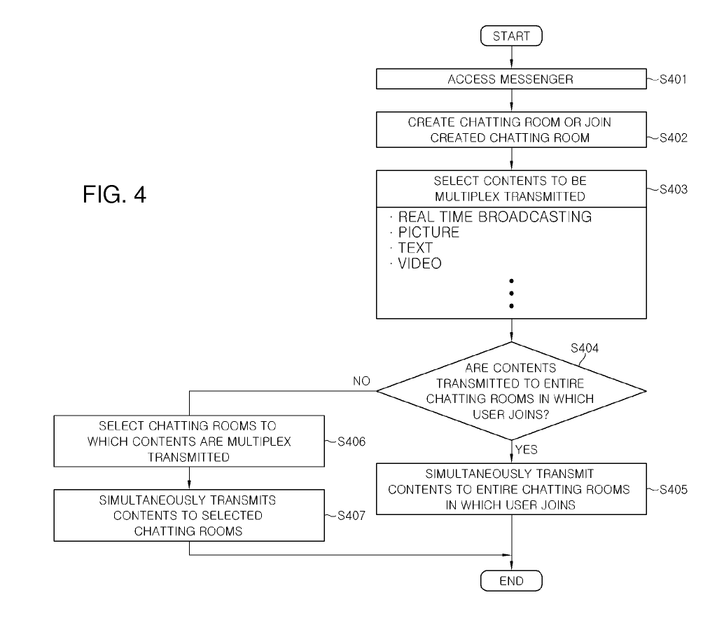

FIG. 4 is a flow chart illustrating a process for multiplex transmitting contents through chatting windows of a messenger service according to an exemplary embodiment of the present invention. Referring to FIG. 4, according to an exemplary embodiment of the present invention, first, a user terminal 220 accesses a messenger server 210 and logs in the messenger server 210 in step S401. Next, the user terminal 220 creates a new chatting room or joins the created chatting room in step S402 to perform chatting. In this case, similarly to a general messenger function, a user who is registered as a friend is selected to create a chatting window to create the chatting room. In the chatting room, one-to-one conversation may be performed or a plurality of users join to perform conversation among three or more members.

If the user terminal 220 uses a function which is added to a messenger service to multiplex transmit the contents, the contents may be simultaneously multiplex transmitted to the plurality of chatting rooms according to the exemplary embodiment of the present invention. Therefore, when contents to be multiplex transmitted (for example, real time broadcasting, a picture, a text, or a video) are selected in step S403 and then multiplex transmitted to all chatting rooms in which a user who requests to multiplex transmit the contents joins in step S404, if the user requests to multiplex transmit the selected contents, the selected contents are simultaneously transmitted to the chatting rooms in which the user joins through the corresponding chatting windows. Accordingly, the selected contents are simultaneously transmitted to user terminals 240 of all members who join the chatting rooms in which the user joins.

In contrast, according to another exemplary embodiment of the present invention, when the user selects specific chatting rooms to transmit the contents rather than all chatting rooms which the user joins, the user selects at least one chatting room to which the contents are multiplex transmitted among the plurality of chatting rooms which the user joins in step S406. Next, when the user requests to multiplex transmit the contents to the selected chatting room, the selected contents are simultaneously multiplex transmitted to the user terminals 240 of all members who join the selected chatting room in step S407.

The method according to the exemplary embodiment of the present invention may be implemented as a program command format which may be executed by various computers to be recorded in a computer readable medium. The computer readable medium may include solely a program command, a data file, and a data structure or a combination thereof. The program commands recorded in the medium may be specifically designed or constructed for the present invention or known to those skilled in the art of a computer software to be used. Examples of the computer readable recording medium include magnetic media such as a hard disk, a floppy disk, or a magnetic tape, optical media such as a CD-ROM or a DVD, magneto-optical media such as a floptical disk, and a hardware device which is specifically configured to store and execute the program command such as a ROM, a RAM, and a flash memory. Examples of the program command include not only a machine language code which is created by a compiler but also a high level language code which may be executed by a computer using an interpreter. The hardware device may operate as one or more software modules in order to perform the operation of the present invention and vice versa.

FIG. 5 is a diagram illustrating an example of content multiplex transmission through chatting windows of a messenger service according to an exemplary embodiment of the present invention. Referring to FIG. 5, according to an exemplary embodiment of the present invention, a mobile messenger service is executed in a smart phone 500 and real time broadcasting is selected as content to be multiplex transmitted to a plurality of chatting rooms. The content is requested to be multiplex transmitted so that as illustrated in FIG. 5, a live broadcasting screen board 511 is created at an upper portion of a screen of all chatting rooms 510 in which the user joins. As described above, as the real time broadcasting is performed, the entire chatting window area may be configured to be divided into a real time broadcasting area and a conversation message display area 520. In this case, as described above, a tag 512 notifying that the contents are multiplex transmitted contents is added to be displayed, so that the users may notice that the contents are multiplex transmitted.

The specified matters and limited exemplary embodiments and drawings such as specific elements in the present invention have been disclosed for broader understanding of the present invention, but the present invention is not limited the exemplary embodiments, and various modifications, additions and substitutions are possible from the disclosure by those skilled in the art.

What is claimed is:

1. A messenger server comprising:
a messenger processing module which creates a chatting window in accordance with a request to create the chatting window and transmits and receives a message which is input through the chatting window; and
a multiplex transmitting module which simultaneously multiplex transmits contents selected by a user terminal to at least two chatting rooms which are selected from a plurality of chatting rooms in which a user of the user terminal joins in accordance with a content multiplex transmitting request of the user terminal.

2. The messenger server of claim 1, wherein the multiplex transmitting module simultaneously multiplex transmits the selected contents to all of the plurality of chatting rooms in which the user of the user terminal joins in accordance with the content multiplex transmitting request.

3. The messenger server of claim 1, wherein the multiplex transmitting module further includes a tag inserting unit which inserts a tag notifying that the contents which are multiplex transmitted are multiplex transmitted contents.

4. The messenger server of claim 1, wherein the multiplex transmitting module further includes a feedback processing unit which collectively stores feedback information in a database when the feedback information is generated in specific chatting windows corresponding to the chatting rooms that received the multiplex transmitted contents.

5. The messenger server of claim 4, wherein the feedback information includes a comment or evaluation information on the contents.

6. The messenger server of claim 1, wherein the multiplex transmitting module further includes a statistic processing unit which checks whether members of the chatting rooms that received the multiplex transmitted contents have browsed the multiplex transmitted contents and generates statistic information regarding the check of the members.

7. The messenger server of claim 1, wherein the multiplex transmitting module further includes a charging unit which charges a predetermined amount of fees when the multiplex transmitted contents are simultaneously multiplex transmitted to a predetermined number or more of chatting rooms.

8. The messenger server of claim 1, wherein the contents are any one selected from a text, an image, a video, and a real-time broadcasting video.

9. A method for multiplex transmitting contents through chatting windows of a messenger service, comprising:
creating a chatting window in a messenger server in accordance with a chatting window creating request, and transmitting and receiving a message which is input through the chatting window;
selecting contents to be multiplex transmitted by a user terminal in communication with the messenger server in accordance with a content multiplex transmitting request from the user terminal; and
simultaneously multiplex transmitting the selected contents to user terminals of other members who join in at least two chatting rooms selected from a plurality of chatting rooms in which a user of the user terminal joins.

10. The method of claim 9, wherein the multiplex transmitting of the selected contents simultaneously multiplex transmits the selected contents to all of the plurality of chatting rooms in which the user of the user terminal joins in accordance with the content multiplex transmitting request.

11. The method of claim 9, wherein the multiplex transmitting of the selected contents further includes inserting a tag notifying that the contents which are multiplex transmitted are multiplex transmitted contents.

12. The method of claim 9, further comprising:
collectively storing feedback information in a database when the feedback information is generated in a specific chatting windows corresponding to the chatting rooms that received the multiplex transmitted contents.

13. The method of claim 12, wherein the feedback information includes a comment or evaluation information on the contents.

14. The method of claim 9, further comprising:
checking whether members of the chatting rooms that received the multiplex transmitted contents have browsed the multiplex transmitted contents and generating statistic information regarding the check of the members.

15. The method of claim 9, further comprising:
charging a predetermined amount of fees when the multiplex transmitted contents are simultaneously multiplex transmitted to a predetermined number or more of chatting rooms.

16. The method of claim 9, wherein the contents are any one selected from a text, an image, a video, and a real-time broadcasting video.

17. A non-transitory computer readable recording medium storing a program for multiplex transmitting contents through chatting windows of a messenger service, the program when executed by a processor comprising:
creating a chatting window in a messenger server in accordance with a chatting window creating request, and transmitting and receiving a message which is input through the chatting window;
selecting contents to be multiplex transmitted by a user terminal in communication with the messenger server in accordance with a content multiplex transmitting request from the user terminal; and
simultaneously multiplex transmitting the selected contents to user terminals of other members who join in at least two chatting rooms selected from a plurality of chatting rooms in which a user of the user terminal joins.
